(19) United States
(12) Patent Application Publication
(10) Pub. No.: US 2018/0211197 A1
(43) Pub. Date: Jul. 26, 2018

(54) METRIC CORRELATION

(71) Applicant: ENTIT Software LLC, Sunnyvale, CA (US)

(72) Inventors: Frank Vosseler, Boeblingen (DE); Joern Schimmelpfeng, Boeblingen (DE); Carsten Schlipf, Boeblingen (DE)

(21) Appl. No.: 15/744,088

(22) PCT Filed: Jul. 13, 2015
(86) PCT No.: PCT/US2015/040090

§ 371 Date: Jan. 12, 2018

(51) Int. Cl. G06Q 10/06

(52) U.S. Cl. CPC G06Q 10/06393; G06Q 30/016; G06Q 10/06398

(57) ABSTRACT

Examples disclosed herein relate to metric correlation instructions to collect a plurality of user action metrics, collect a plurality of business objective metrics, calculate a plurality of correlation values between the user action metrics and the business objective metrics, wherein each calculation comprises a time shift value of the plurality of business objective metrics, and identify a latency period between the user action metrics and the business objective metrics according the calculated plurality of correlation values.

### BACKGROUND

Gamification initiatives may allow for providing incentives associated with various activities or progress toward a goal. These incentives may be used to drive improvements in various objectives. For example, an objective of increasing a knowledge base may be driven by offering incentives for users to write new articles.

### BRIEF DESCRIPTION OF THE DRAWINGS

In the accompanying drawings, like numerals refer to like components or blocks. The following detailed description references the drawings, wherein:

FIG. 1 is a block diagram of an example metric correlation device;

FIG. 2A-2C are charts illustrating an example user action metric and an example business objective metric correlation;

FIG. 3 is a block diagram of an example system for metric correlation; and

FIG. 4 is a flowchart of an example of a method for metric correlation.

### DETAILED DESCRIPTION

Gamification may comprise the concept of applying game mechanics and game design techniques to engage and motivate people to achieve their goals. Many enterprises use this as a tool for the motivation of the employees and to influence the workforce towards achieving better business results. An example is Help Desk organizations that recognize the authors of frequent Knowledge Base (KB) articles with an “expert” badge. In addition to the employee satisfaction from the recognition, the underlying business objective is to increase Help Desk effectiveness through a better knowledge base.

In some situations, the connection of particular gamification initiatives to business objectives may not be recorded and can get lost, and the effectiveness of games is often measured by the gamified metric (number of KB articles), instead of the actual business objective (improved Meantime to Resolve in the Help Desk). As a consequence, gamification initiatives are at risk to miss their actual objective, or even worse, to waste labor cost without a positive business effect.

Gamification initiatives may thus comprise programs designed to drive improvements in business processes. These initiatives often offer scoring, points, and/or rewards for completing actions and tasks or making progress toward improving the business process. In the help desk example above, employees may be given points for each knowledge base article they write and/or for each article that is rated as helpful by a customer. The knowledge base improvements may be measured by a metric associated with the business process, such as a number of active support tickets, a mean time to closing of support tickets, and/or a number of support tickets closed by the originating customer rather than by helpdesk employees due to having found the solution in the knowledge base.

In the description that follows, reference is made to the term, “machine-readable storage medium.” As used herein, the term “machine-readable storage medium” refers to any electronic, magnetic, optical, or other physical storage device that stores executable instructions or other data (e.g., a hard disk drive, random access memory, flash memory, etc.).

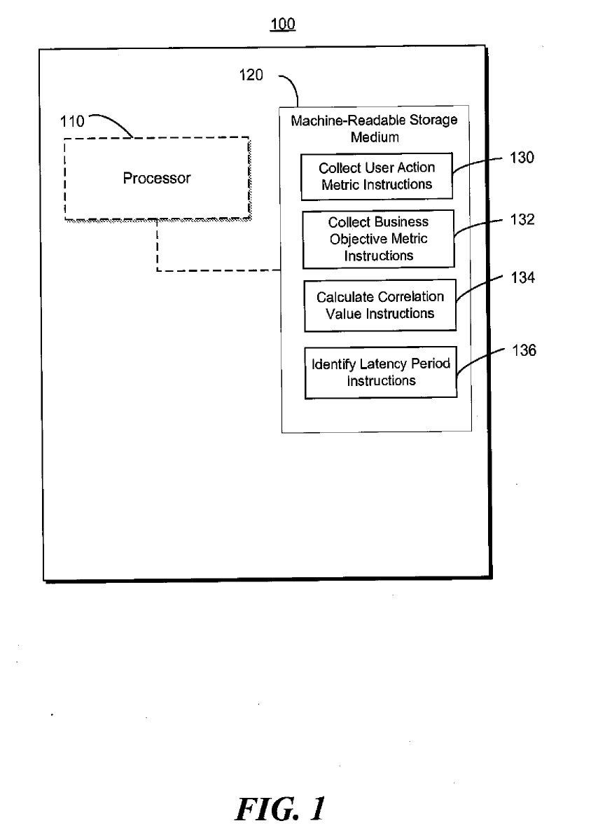

Referring now to the drawings, FIG. 1 is a block diagram of an example metric correlation device 100 consistent with disclosed implementations. Metric correlation device 100 may comprise a processor 110 and a non-transitory machine-readable storage medium 120. Metric correlation device 100 may comprise a computing device such as a server computer, a desktop computer, a laptop computer, a handheld computing device, a smart phone, a tablet computing device, a mobile phone, or the like.

Processor 110 may comprise a central processing unit (CPU), a semiconductor-based microprocessor, or any other hardware device suitable for retrieval and execution of instructions stored in machine-readable storage medium 120. In particular, processor 110 may fetch, decode, and execute a plurality of collect user action metric instructions 130, collect business objective metric instructions 132, calculate correlation value instructions 134, and identify latency period instructions 136 to implement the functionality described in detail below.

Executable instructions may be stored in any portion and/or component of machine-readable storage medium 120. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Collect user action metric instructions 130 may collect a plurality of user action metrics. For example, instructions 130 may retrieve, receive, and/or gather a set of measurements related to various user actions associated with a rewarded action of a gamification initiative. Such metrics may be collected as the user actions are performed and/or retrieved from a storage such as a database updated by other processes. For example, for a gamification initiative may be designed with the goal of improving the mean resolution time of help desk tickets, the user action metric may comprise a number of knowledge base articles written by help desk employees over a given period. A scorecard application, for example, may record and reward the user actions associated with various gamification initiatives.

Collect business objective metric instructions 132 may collect a plurality of business objective metrics. For example, instructions 130 may retrieve, receive, and/or gather a set of measurements related to various business objectives associated with a goal of a gamification initiative. Such metrics may be collected as the user actions are performed and/or retrieved from a storage such as a database updated by other processes. For example, for a gamification initiative may be designed with the goal of improving the mean resolution time of help desk tickets, the user action metric may comprise a number of knowledge base articles written by help desk employees over a given period. A scorecard application, for example, may record the time between the creation and closing of each help desk ticket.

Calculate correlation value instructions 134 may calculate a plurality of correlation values between the user action metrics and the business objective metrics, wherein each calculation comprises a time shift value of the plurality of business objective metrics. The calculation of correlation values may be applied to averages of numerous data points over progressively shorter intervals. For example, a periodic measurement of the user action metrics (e.g., knowledge base articles created) and the business objective metrics (e.g., support tickets closed by original user instead of help desk employee) may be made and averaged for a first interval, such as one week, resulting in the data displayed below in Table 1.

In some implementations, the individual data points for each interval may be averaged before or after the time shift has been applied. In the examples shown below in Table 1, the time shift has been applied to the business objective metrics before the individual data points for each interval have been averaged. Other examples may average the business objective metrics and then apply the time shift value to the average of the intervals. For example, a set of user action metrics may comprise 50 individual data measurements and a set of business objective metrics may comprise a corresponding set of 50 data measurements. The first interval may comprise 10 data measurements to be averaged, producing five corresponding data points for each of the user action and business objective metrics. The interval may then be time shifted by a given amount, such as +1-5 data points with respect to the business objective measurements. New averages of the individual business objective measurements may be taken over these intervals, and correlation values for each time shift—positive, neutral, and negative—may be calculated.

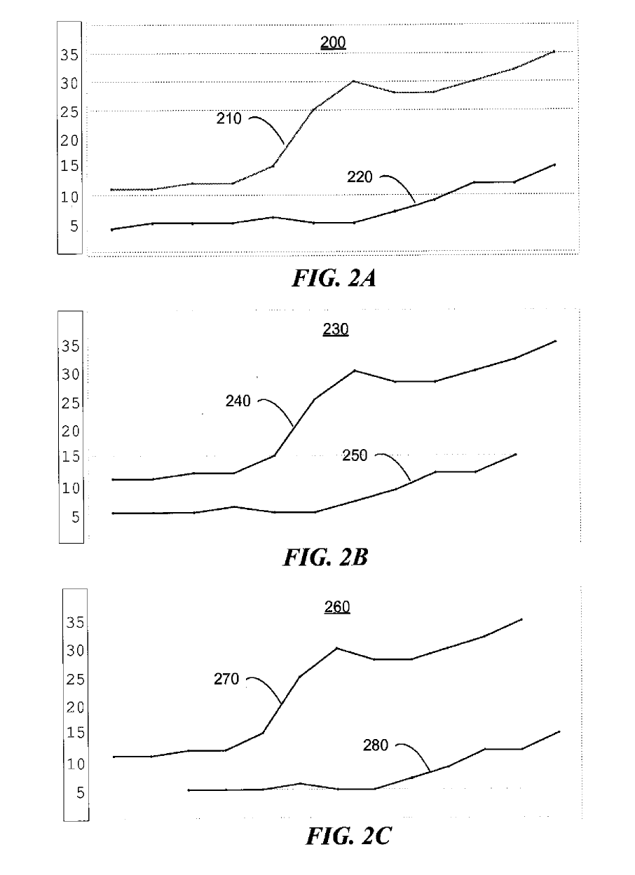

FIG. 2A is a chart 200 illustrating user action metric and business objective metric correlation for a zero time shift based on the data in Table 1. A first user action metric line 210 represents an average of the user action metric for each interval (e.g., one week). A first business objective metric line 220 represents an average of the business objective metric for each interval.

TABLE 1

| | | Business | Business | Business |
|---|---|---|---|---|
| | User | Objective | Objective | Objective |
| Interval | Action | (Zero Shift) | (Negative Shift) | (Positive Shift) |
| 1 | 11 | 4 | 5 | |
| 2 | 11 | 5 | 5 | 4 |
| 3 | 12 | 5 | 5 | 5 |
| 4 | 12 | 5 | 6 | 5 |
| 5 | 15 | 6 | 5 | 5 |
| 6 | 25 | 5 | 5 | 6 |
| 7 | 30 | 5 | 7 | 5 |
| 8 | 28 | 7 | 9 | 5 |
| 9 | 28 | 9 | 12 | 7 |
| 10 | 30 | 12 | 12 | 9 |
| 11 | 32 | 12 | 15 | 12 |
| 12 | 35 | 15 | | 12 |

Each metric may be sampled over a time interval. In some implementations, a first interval size may comprise twice a maximum expected latency between enacting the gamification initiative and measuring an impact on the business objective metric. The user action and business objective metrics may be averaged over each interval to provide a highly compressed and time-leveled representation of every metric. The user action and business objective metrics may be compared using a correlation such as a Pearson correlation coefficient to generate a statistical measure for the similarity of two data series over time.

The correlation calculation may be performed for a plurality of time shift values, such as zero shift, negative shift, and/or positive shift. For example, the time shifts may take half of the interval over which the metrics were averaged and re-average them after shifting the starting point of the data series either forward (positive time shift) or backward (negative time shift).

FIG. 2B is a chart 230 illustrating user action metric and business objective metric correlation for a negative time shift based on the data in Table 1. A second user action metric line 240 represents an average of the user action metric for each interval (e.g., one week). A second business objective metric line 250 represents an average of the business objective metric for each negative time-shifted interval. For a one week interval, for example, a negative time shift may begin averaging a week's worth of business object metrics 3.5 days earlier than the starting time for the user action metric data.

FIG. 2C is a chart 260 illustrating user action metric and business objective metric correlation for a positive time shift based on the data in Table 1. A third user action metric line 270 represents an average of the user action metric for each interval (e.g., one week). A third business objective metric line 280 represents an average of the business objective metric for each positive time-shifted interval. For a one week interval, for example, a positive time shift may begin averaging a week's worth of business object metrics 3.5 days later than the starting time for the user action metric data.

A correlation between the user action and business objective metrics is calculated to determine if one of the time shift values results in a higher correlation value. The negative time shift of FIG. 2B, for example, results in a closer correlation between an increase in the user action metric and the business objective metric, potentially indicating an effectiveness of the business objective.

In some implementations, the correlation calculation may be refined by iteratively splitting up the interval size (e.g., reducing by one half) to make the averages more fine grained. More fine grained intervals may reduce the time leveling effect. The reduced interval may be applied to the original, zero time shifted metrics and/or to the time-shifted data resulting in the highest correlation. For example, the data in Table 1 indicates that the negative time shift of the business objective metric averages had the highest correlation with the user action metrics. Averages for the new, shorter interval (e.g, three days), may begin at the zero time shift for the user action metrics but at the negatively time shifted point for the business objective metrics. A correlation drop for all of the time shifts for a given interval may indicate no significant correlation and/or that the highest correlation point has been passed.

Identify latency period instructions 136 may identify a latency period between the user action metrics and the business objective metrics according the calculated plurality of correlation values. For example, the iterative correlation calculations may result in a highest correlation point after the business objective metrics have been negatively time shifted by 4.8 days. This may indicate a latency period between commencement of the gamification initiative and effect on the business objective of 4.8 days.

In some implementations, latency results may provide an indication of the gamification initiative's effectiveness. A lack of improvement in the correlation, or a decreasing correlation value from an initial, zero time shift, may indicate an ineffective and/or harmful initiative. A short latency period with a high correlation value and/or a large improvement from the first correlation value to the highest calculated correlation value may indicate a successful initiative.

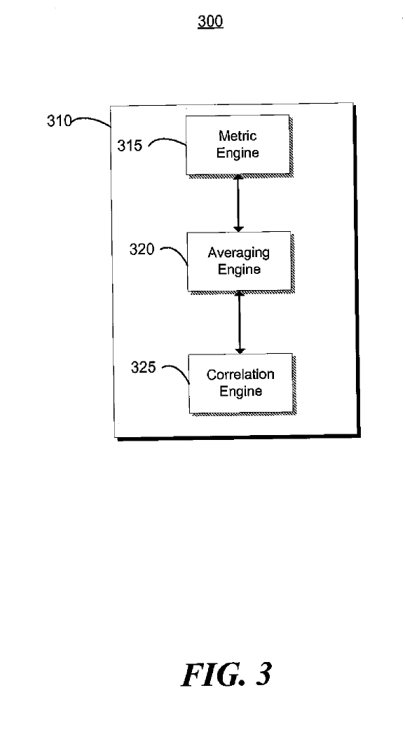

FIG. 3 is a block diagram of a system 300 for metric correlation. System 300 may comprise a computing device 310 comprising a metric engine 315, an averaging engine 320, and a correlation engine 325. System 300 may further comprise a plurality of virtual machines (VMs) 340(A)-(C).

Computing device 310 may comprise, for example, a general and/or special purpose computer, server, mainframe, desktop, laptop, tablet, smart phone, game console, and/or any other system capable of providing computing capability consistent with providing the implementations described herein.

Each of engines 315, 320, and 325 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 315, 320, and 325. In such examples, system 300 may comprise the machine-readable storage medium storing the instructions and the processing resource to execute the instructions, or the machine-readable storage medium may be separate but accessible to system 300 and the processing resource.

Metric engine 315 may receive a plurality of user action metrics associated with a gamification initiative and receive a plurality of business objective metrics associated with the gamification initiative. For example, metric engine 315 may execute collect user action metric instructions 130 and collect business objective metric instructions 132 may collect each set of metrics. For example, instructions 130, 132 may retrieve, receive, and/or gather a set of measurements related to various user actions and business objectives associated with the rewards and goals of a gamification initiative. Such metrics may be collected as the user actions are performed and/or retrieved from a storage such as a database updated by other processes. For example, for a gamification initiative may be designed with the goal of improving the mean resolution time of help desk tickets, the user action metric may comprise a number of knowledge base articles written by help desk employees over a given period. A scorecard application, for example, may record and reward the user actions associated with various gamification initiatives and/or the performance of the business objective.

Averaging engine 320 may select a plurality of time intervals, calculate a set of user action metric averages for each of the plurality of time intervals, and calculate a set of business objective metric averages for each of the plurality of time intervals. Each subsequent time interval of the plurality of time intervals may comprise a shorter time interval than the prior time interval.

For example, a periodic measurement of the user action metrics (e.g., knowledge base articles created) and the business objective metrics (e.g., support tickets closed by original user instead of help desk employee) may be made and averaged for a first interval, such as one week, resulting in the data displayed above in Table 1.

Each metric may be sampled over a time interval. In some implementations, a first interval size may comprise twice a maximum expected latency between enacting the gamification initiative and measuring an impact on the business objective metric. The user action and business objective metrics may be averaged over each interval to provide a highly compressed and time-leveled representation of every metric. The user action and business objective metrics may be compared using a correlation such as a Pearson correlation coefficient to generate a statistical measure for the similarity of two data series over time.

Correlation engine 325 may calculate a respective correlation value for a set of time shift values between the set of user action metric averages and the set of business objective metric averages for each of the plurality of time intervals. The time shift values may comprise a zero time shift, a positive time shift, and/or a negative time shift. In some implementations multiple positive and/or multiple negative time shift values may be applied to the metric averages for each time interval. The correlation calculation may be performed for a plurality of time shift values, such as zero shift, negative shift, and/or positive shift. For example, the time shifts may take half of the interval over which the metrics were averaged and re-average them after shifting the starting point of the data series either forward (positive time shift) or backward (negative time shift).

Correlation engine 325 may identify a highest correlation value between the set of user action metric averages and the set of business objective metric averages for each of the plurality of time intervals. A correlation between the user action and business objective metrics is calculated to determine if one of the time shift values results in a higher correlation value. The negative time shift of FIG. 2B, for example, results in a closer correlation between an increase in the user action metric and the business objective metric, potentially indicating an effectiveness of the business objective.

In some implementations, the correlation calculation may be refined by iteratively splitting up the interval size (e.g., reducing by one half) to make the averages more fine grained. More fine grained intervals may reduce the time leveling effect. The reduced interval may be applied to the original, zero time shifted metrics and/or to the time-shifted data resulting in the highest correlation. For example, the data in Table 1 indicates that the negative time shift of the business objective metric averages had the highest correlation with the user action metrics. Averages for the new, shorter interval (e.g, three days), may begin at the zero time shift for the user action metrics but at the negatively time shifted point for the business objective metrics. A correlation drop for all of the time shifts for a given interval may indicate no significant correlation and/or that the highest correlation point has been passed.

Correlation engine 325 may report an effectiveness of the gamification initiative according to the highest correlation value. The effectiveness of the gamification initiative may be based, for example, on a latency period between commencement of the gamification initiative and a change in the plurality of business objective metrics, an improvement in the plurality of business objective metrics, and/or a comparison of the highest correlation value with a second correlation value. In some implementations, the second correlation value may be associated with a second gamification initiative. For example, a second initiative may be associated with a different user action to improve the same business objective. A comparison of the correlation values between the two gamification initiatives may provide insight into which initiative was more effective.

For example, correlation engine 325 may execute identify latency period instructions 136 to identify a latency period between the user action metrics and the business objective metrics according the calculated plurality of correlation values. For example, the iterative correlation calculations may result in a highest correlation point after the business objective metrics have been negatively time shifted by 4.8 days. This may indicate a latency period between commencement of the gamification initiative and effect on the business objective of 4.8 days.

In some implementations, latency results may provide an indication of the gamification initiative's effectiveness. A lack of improvement in the correlation, or a decreasing correlation value from an initial, zero time shift, may indicate an ineffective and/or harmful initiative. A short latency period with a high correlation value and/or a large improvement from the first correlation value to the highest calculated correlation value may indicate a successful initiative.

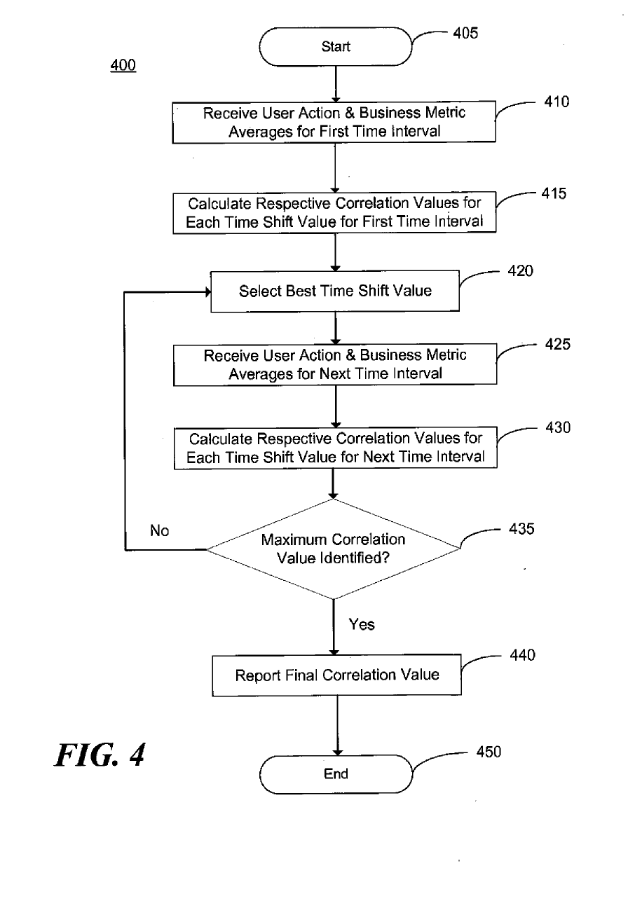

FIG. 4 is a flowchart of a method 400 for metric correlation consistent with disclosed implementations. Although execution of method 400 is described below with reference to the components of metric correlation device 100, other suitable components for execution of method 400 may be used.

Method 400 may begin in stage 405 and proceed to stage 410 where device 100 may receive a first plurality of user action metric averages and a first plurality of business objective metric averages for a first plurality of time intervals.

For example, instructions 130, 132 may retrieve, receive, and/or gather a set of measurements related to various user actions and business objectives associated with the rewards and goals of a gamification initiative. Such metrics may be collected as the user actions are performed and/or retrieved from a storage such as a database updated by other processes. For example, for a gamification initiative may be designed with the goal of improving the mean resolution time of help desk tickets, the user action metric may comprise a number of knowledge base articles written by help desk employees over a given period. A scorecard application, for example, may record and reward the user actions associated with various gamification initiatives and/or the performance of the business objective.

In some implementations, averaging engine 320 may select a plurality of time intervals, calculate a set of user action metric averages for each of the plurality of time intervals, and calculate a set of business objective metric averages for each of the plurality of time intervals. Each subsequent time interval of the plurality of time intervals may comprise a shorter time interval than the prior time interval.

A periodic measurement of the user action metrics (e.g., knowledge base articles created) and the business objective metrics (e.g., support tickets closed by original user instead of help desk employee) may be made and averaged for a first interval, such as one week, resulting in the data displayed above in Table 1.

Method 400 may then advance to stage 415 where device 100 may calculate, for the first plurality of intervals, a first respective correlation value for each of a plurality of time shift values applied to the first plurality of business objective metrics. For example, correlation engine 325 may identify a highest correlation value between the set of user action metric averages and the set of business objective metric averages for each of the plurality of time intervals. A correlation between the user action and business objective metrics is calculated to determine if one of the time shift values results in a higher correlation value. The negative time shift of FIG. 2B, for example, results in a closer correlation between an increase in the user action metric and the business objective metric, potentially indicating an effectiveness of the business objective.

In some implementations, the correlation calculation may be refined by iteratively splitting up the interval size (e.g., reducing by one half) to make the averages more fine grained. More fine grained intervals may reduce the time leveling effect. The reduced interval may be applied to the original, zero time shifted metrics and/or to the time-shifted data resulting in the highest correlation. For example, the data in Table 1 indicates that the negative time shift of the business objective metric averages had the highest correlation with the user action metrics. Averages for the new, shorter interval (e.g, three days), may begin at the zero time shift for the user action metrics but at the negatively time shifted point for the business objective metrics. A correlation drop for all of the time shifts for a given interval may indicate no significant correlation and/or that the highest correlation point has been passed.

Method 400 may then advance to stage 420 where device 100 may select a best time shift value of the plurality of time shift values according to the first respective correlation value for each of the plurality of time shift values. For example, the highest correlation value may be used to select the best time shift value.

Method 400 may then advance to stage 425 where device 100 may receive a second plurality of user action metric averages and a second plurality of business objective metric averages for a second plurality of time intervals. The second plurality of time intervals may comprise a shorter time interval tan the first plurality of time intervals. For example, each of the first plurality of user action and business objective metrics may be associated with ten day time intervals, while each of the second plurality of user action and business objective metrics may be associated with five day time intervals. The averages may be received as described above with respect to stage 410.

Method. 400 may then advance to stage 430 where device 100 may calculate, for the second plurality of intervals, a second respective correlation value for each of the plurality of time shift values applied to the second plurality of business objective metrics. The correlation values may be calculated as described above with respect to stage 415.

Method 400 may then advance to stage 435 where device 100 may determine whether a maximum correlation value has been identified. For example, if the correlation values of all of the time shifts applied to the second plurality of metric averages are lower than the highest correlation value of the previous plurality of metric averages, then that highest correlation value may be identified as the maximum. Further time shifts are unlikely to refine and/or improve the correlation value.

If the maximum correlation value has not been identified, method 400 may return to stage 420 where the best time shift value and/or highest correlation value for the current set of averages may be selected, and the metrics may be further refined by reducing the time interval for averaging the metrics. Otherwise, method 400 may advance to stage 440 where device 100 may report the final correlation value between the user action metric and the business objective metric. For example, correlation engine 325 may report an effectiveness of the gamification initiative according to the highest correlation value. The effectiveness of the gamification initiative may be based, for example, on a latency period between commencement of the gamification initiative and a change in the plurality of business objective metrics, an improvement in the plurality of business objective metrics, and/or a comparison of the highest correlation value with a second correlation value. In some implementations, the second correlation value may be associated with a second gamification initiative. For example, a second initiative may be associated with a different user action to improve the same business objective. A comparison of the correlation values between the two gamification initiatives may provide insight into which initiative was more effective.

For example, correlation engine 325 may execute identify latency period instructions 136 to identify a latency period between the user action metrics and the business objective metrics according the calculated plurality of correlation values. For example, the iterative correlation calculations may result in a highest correlation point after the business objective metrics have been negatively time shifted by 4.8 days. This may indicate a latency period between commencement of the gamification initiative and effect on the business objective of 4.8 days.

In some implementations, latency results may provide an indication of the gamification initiative's effectiveness. A lack of improvement in the correlation, or a decreasing correlation value from an initial, zero time shift, may indicate an ineffective and/or harmful initiative. A short latency period with a high correlation value and/or a large improvement from the first correlation value to the highest calculated correlation value may indicate a successful initiative.

Method 400 may then end at stage 450.

The disclosed examples may include systems, devices, computer-readable storage media, and methods for metric correlation. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium comprising instructions which, when executed by a processor, cause the processor to:
collect a plurality of user action metrics;
collect a plurality of business objective metrics;
calculate a plurality of correlation values between the plurality of user action metrics and the plurality of business objective metrics, wherein each calculation comprises a time shift value of the plurality of business objective metrics; and
identify a latency period between the user action metrics and the business objective metrics according the calculated plurality of correlation values.

2. The non-transitory machine-readable medium of claim 1, wherein the plurality of user action metrics each comprise a rewarded action of a gamification initiative.

3. The non-transitory machine-readable medium of claim 2, further comprising instructions to cause the processor to determine whether the gamification initiative is associated with an improvement in the plurality of business objective metrics.

4. The non-transitory machine-readable medium of claim 1, wherein a first correlation value of the plurality of correlation values is calculated according to a first plurality of averages of a time interval of the user action metrics.

5. The non-transitory machine-readable medium of claim 4, wherein the time shift value of each calculation comprises a portion of the time interval.

6. The non-transitory machine-readable medium of claim 4, wherein a second correlation value of the plurality of correlation values is calculated according to a second plurality of averages of a second time interval of the user action metrics.

7. The non-transitory machine-readable medium of claim 6, wherein second time interval comprises a shorter interval than the first time interval.

8. A system, comprising:
a metric engine to:
receive a plurality of user action metrics associated with a gamification initiative, and
receive a plurality of business objective metrics associated with the gamification initiative;
an averaging engine to:
select a plurality of time intervals,
calculate a set of user action metric averages for each of the plurality of time intervals, and
calculate a set of business objective metric averages for each of the plurality of time intervals; and
a correlation engine to:
calculate a respective correlation value for a set of time shift values between the set of user action metric averages and the set of business objective metric averages for each of the plurality of time intervals,
identify a highest correlation value between the set of user action metric averages and the set of business objective metric averages for each of the plurality of time intervals, and
report an effectiveness of the gamification initiative according to the highest correlation value.

9. The system of claim 8, wherein each successive time interval of the plurality of time intervals comprises a shorter time interval than the previous time interval of the plurality of time intervals.

10. The system of claim 8, wherein the effectiveness of the gamification initiative comprises a latency period between commencement of the gamification initiative and a change in the plurality of business objective metrics.

11. The system of claim 10, wherein the effectiveness of the gamification initiative further comprises an improvement in the plurality of business objective metrics.

12. The system of claim 10, wherein the effectiveness of the gamification initiative further comprises a comparison of the highest correlation value with a second correlation value.

13. The system of claim 12, wherein the second correlation value is associated with a second gamification initiative.

14. A computer-implemented method comprising:
receiving a first plurality of user action metric averages for a first plurality of intervals;
receiving a first plurality of business objective metric averages for the first plurality of intervals;
calculating, for the first plurality of intervals, a first respective correlation value for each of a plurality of time shift values applied to the first plurality of business objective metrics;
selecting a best time shift value of the plurality of time shift values according to the first respective correlation value for each of the plurality of time shift values;
receiving a second plurality of user action metric averages for a second plurality of intervals;
receiving a second plurality of business objective metric averages for the second plurality of intervals;
calculating, for the second plurality of intervals, a second respective correlation value for each of the plurality of time shift values applied to the second plurality of business objective metrics;
determining whether a maximum correlation value has been identified; and
in response to determining that a maximum correlation value has been identified, reporting a final correlation value between the user action metric and the business objective metric.

15. The computer-implemented method of claim 8, further comprising, in response to determining that a maximum correlation value has not been identified:
calculating a third plurality of user action metric averages for a third plurality of intervals;
calculating a third plurality of business objective metric averages for the third plurality of intervals;
calculating, for the third plurality of intervals, a third respective correlation value for each of the plurality of time shift values applied to the third plurality of business objective metrics; and
determining whether the maximum correlation value has been identified, wherein determining whether the maximum correlation value has been identified comprises determining whether the third respective correlation value for each of the plurality of time shift values applied to the third plurality of business objective metrics is less than the second respective correlation value for each of the plurality of time shift values applied to the second plurality of business objective metrics.
